(19) United States
(12) Patent Application Publication
(10) Pub. No.: US 2019/0147749 A1
(43) Pub. Date: May 16, 2019

(54) System and Method for Mission Planning, Flight Automation, and Capturing of High-Resolution Images by Unmanned Aircraft

(71) Applicant: Geomni, Inc., Jersey City, NJ (US)

(72) Inventors: Jeffery Devon Lewis, Orem, UT (US); Jeffrey Clayton Taylor, Highland, UT (US); Corey David Reed, Cedar Hills, UT (US); Troy Tomkinson, Saratoga Springs, UT (US)

(73) Assignee: Geomni, Inc., Jersey City, NJ (US)

(21) Appl. No.: 16/189,389

(22) Filed: Nov. 13, 2018

Related U.S. Application Data
(60) Provisional application No. 62/585,093, filed on Nov. 13, 2017.

(51) Int. Cl. G08G 5/00; B64C 39/02; G08G 5/04

(52) U.S. Cl. CPC G08G 5/0034; B64C 39/024; B64C 2201/123; G08G 5/0069; G08G 5/045; G08G 5/0039

(57) ABSTRACT

A system and method for mission planning, flight automation, and capturing of high-resolution images by unmanned aircraft is provided. The system includes at least one hardware processor including a controller configured to generate and execute a flight plan that automatically detects and avoids obstacles present in a flight path for capturing the high-resolution images, requiring no (or, minimal) user involvement. The system can also predict obstacles in flight paths, and automatically calculate a flight path that avoids predicted obstacles.

### CROSS-REFERENCE TO RELATED APPLICATIONS

This application claims the benefit of U.S. Provisional Patent Application No. 62/585,093, filed on Nov. 13, 2017, the entire disclosure of which is expressly incorporated herein by reference.

### BACKGROUND

### Technical Field

The present disclosure relates generally to the field of unmanned aircraft technology. More specifically, the present disclosure relates to a system and method for mission planning, flight automation, and capturing of high-resolution images by unmanned aircraft.

### Related Art

In the unmanned aircraft field, increasingly sophisticated software-based systems are being developed for flight planning and flight automation. Such systems have wide applicability, including but not limited to, navigation, videography and other fields of endeavor. In the field of aerial image processing, there is particular interest in the application of unmanned aircraft systems for automatically generating and executing a flight plan to capture high-resolution images of one or more desired features present in the images (e.g., models of buildings, other structures, portions and/or attributes of buildings/structures, property features, etc.).

There is currently significant interest in the unmanned aircraft field in developing systems that generate and execute a flight plan for capturing images of structures and property present in such images with minimal user involvement. For example, it would be highly beneficial to develop systems that can automatically detect and avoid obstacles present in a flight path for capturing the images, requiring no (or, minimal) user involvement, and with a high degree of accuracy. Still further, there is a need for systems which can automatically generate and execute flight plans for capturing high-resolution images, which do not include any obstacles in the flight path. Accordingly, the system of the present disclosure addresses these and other needs.

### SUMMARY

The present disclosure relates to a system and method for mission planning, flight automation, and capturing of high-resolution images by unmanned aircraft. The system includes at least one hardware processor including a controller configured to generate and execute a flight plan that automatically detects and avoids obstacles present in a flight path for capturing the high-resolution images, requiring no (or, minimal) user involvement. The system can also predict obstacles in flight paths, and automatically calculate a flight path that avoids predicted obstacles.

The system first loads an imagery map of the capture area including a 3D model of a structure to be imaged within the capture area from an imagery database. The imagery could include, but is not limited to, aerial imagery, LiDAR imagery, satellite imagery, etc. Alternatively, the system can generate a real-time aerial imagery map in addition to a contour or bounding geometry of the structure to be imaged based on a drawing made by a user and input into the system. Then, the system generates a flight plan based on criteria to capture high-resolution images of one or more desired features present in the images (such as a structure, a portion or attribute of a structure, and/or property). The system then compares the aerial imagery map with the generated flight plan and determines whether there are possible collisions between obstacles associated with the aerial imagery map (e.g., trees, power lines, windmills, etc.) and the unmanned aircraft. If collisions are not present, the system executes the initial flight plan. If collisions are present, the system modifies the flight plan to avoid the obstacles and executes the modified flight plan.

The system then monitors an elevation between the unmanned aircraft and the structure to be captured and determines whether there is a change in elevation between the unmanned aircraft and the structure. If there is a change in elevation, the system determines whether the unmanned aircraft is equipped with a zoom lens for capturing images of the structure. If the unmanned aircraft is equipped with a zoom lens, the system adjusts the zoom lens to maintain a desired image resolution based on the change in elevation between the unmanned aircraft and the structure. Alternatively, if the unmanned aircraft is not equipped with a zoom lens, the system adjusts a flight plan elevation of the unmanned aircraft to maintain the desired image resolution based on the change in elevation between the unmanned aircraft and the structure. However, if a change in elevation between the unmanned aircraft and the structure is not present, the system executes one of the initial flight plan and the modified flight plan.

### BRIEF DESCRIPTION OF THE DRAWINGS

The foregoing features of the present disclosure will be apparent from the following Detailed Description of the Invention, taken in connection with the accompanying drawings, in which:

FIG. 1 is a diagram illustrating hardware and software components capable of being utilized to implement the system of the present disclosure;

FIG. 2 is a flowchart illustrating processing steps carried out by the system of the present disclosure;

FIG. 3A is a flowchart illustrating step 46a of FIG. 2 in greater detail;

FIG. 3B is a flowchart illustrating step 46b of FIG. 2 in greater detail;

FIG. 4A is a diagram illustrating a 3D model of a structure in a capture area;

FIG. 4B is a diagram illustrating a bounding geometry of a structure in a capture area;

FIG. 5 is a flowchart illustrating process steps for navigating a flight path of a flight plan;

FIG. 6 is a diagram illustrating a flight path of a flight plan generated by the system;

FIG. 7 is a flowchart illustrating process steps for navigating a flight path of a flight plan;

FIG. 8 is a flowchart illustrating step 52 of FIG. 2 in greater detail;

FIG. 9 is a diagram illustrating a flight path of a flight plan generated by the system;

FIG. 10 is a diagram illustrating a flight path of a flight plan generated by the system according to step 170 of FIG. 8;

FIG. 11 is a diagram illustrating a flight path of a flight plan generated by the system according to step 178 of FIG. 8;

FIG. 12 is a diagram illustrating a flight path of a flight plan generated by the system according to steps 188a and 190a of FIG. 8;

FIG. 13 is a diagram illustrating a flight path of a flight plan generated by the system according to steps 188b and 190b of FIG. 8;

FIG. 14 is a flowchart illustrating step 182 of FIG. 8 in greater detail;

FIG. 15A is a flowchart illustrating steps 62 and 80 of FIG. 2 in greater detail;

FIG. 15B is a diagram illustrating a flight path of a flight plan generated by the system according to steps 62 and 80 of FIG. 2;

FIG. 16A is a flowchart illustrating steps 66 and 84 of FIG. 2 in greater detail;

FIG. 16B is a diagram illustrating a flight path of a flight plan generated by the system according to steps 66 and 84 of FIG. 2;

FIG. 17 is a flowchart illustrating processing steps carried out by the real-time aerial map generation module 26a of FIG. 1; and

FIG. 18 is a flowchart illustrating step 242 of FIG. 17 in greater detail.

FIG. 19 is a flowchart illustrating processing steps carried out by the dynamic flight plan modification module 22c of FIG. 1 in greater detail;

FIG. 20A is a flowchart illustrating step 290 of FIG. 19 in greater detail; and

FIG. 20B is a flowchart illustrating step 290 of FIG. 19 in greater detail.

### DETAILED DESCRIPTION

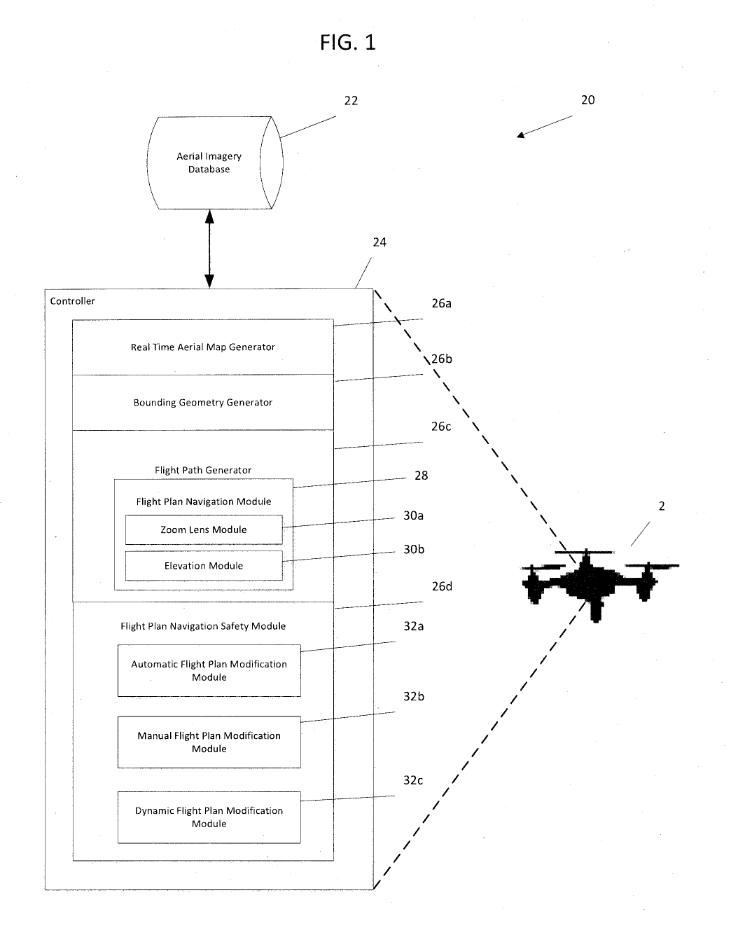

The present disclosure relates to a system and method for mission planning and flight automation for capturing high-resolution images by unmanned aircraft, as described in detail below in connection with FIGS. 1-20B.

Turning to the drawings, FIG. 1 is a diagram illustrating hardware and software components capable of implementing the system of the present disclosure. The system could be embodied as a central processing unit (e.g. a hardware processor) of an unmanned aircraft 2 coupled to an aerial imagery database 22. In another embodiment, the system could be embodied as the unmanned aircraft 2. The hardware processor includes a controller 24 that is configured to generate and execute a flight plan, requiring no (or, minimal) user involvement, that automatically captures high-resolution images while detecting and avoiding obstacles present in a flight path. Alternatively, the system could be embodied as unmanned aircraft system code (non-transitory, computer-readable instructions) stored on a computer-readable medium and executable by the hardware processor.

The controller 24 could include various modules that carry out the steps/processes discussed herein, and could include, but is not limited to, a real-time aerial map generator 26a, a bounding geometry generator 26b, a flight path generator 26c, and a flight plan navigation safety module 26d. The flight path generator 26c could further include a flight plan navigation module 28 having a zoom lens module 30a and an elevation module 30b. The flight plan navigation safety module 26d could further include an automatic flight plan modification module 32a, a manual flight plan modification module 32b and a dynamic flight plan modification module 32c.

The hardware processor could also include, but is not limited to, a personal computer, a laptop computer, a tablet computer, a smart telephone, a server, and/or a cloud-based computing platform. Further, the code could be distributed across multiple computer systems communicating with each other over a communications network, and/or stored and executed on a cloud computing platform and remotely accessed by a computer system in communication with the cloud platform. The code could communicate with the aerial imagery database 12, which could be stored on the same computer system as the code or on one or more other computer systems in communication with the code.

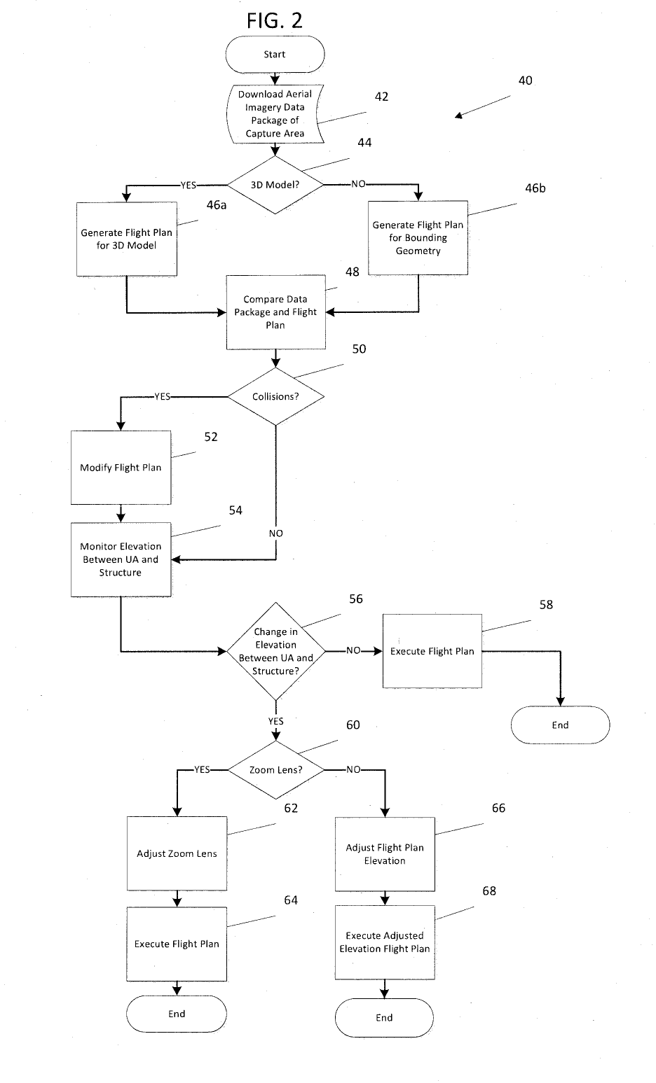

FIG. 2 is a flowchart illustrating processing steps carried out by the controller 24 of FIG. 1. The system of the present disclosure allows for the rapid generation, modification and execution of a flight plan to capture high-resolution images of one or more desired features present in the images (such as a structure, a portion or attribute of a structure, and/or property). The images could include aerial images taken from various angles including, but not limited to, nadir views, oblique views, etc.

Beginning in step 42, the system downloads an aerial image data package of the area to be captured. The data package could be a pre-existing digital surface model (DSM) including, but not limited to, flight path obstacles such as residential and commercial buildings, flagpoles, water towers, windmills, street lamps, trees, power lines, etc. Alternatively, the real-time aerial map generator 26a of FIG. 1 could generate a real-time DTM. In step 44, the system determines whether the data package includes a three dimensional (3D) model of a structure to be imaged. If the 3D model is included, then in step 46a the system generates a flight plan for the 3D model. The initial flight plan for the 3D model could be generated based on a desired overlap between sequential image captures, an image orientation, a desired image resolution, a ceiling elevation and a floor elevation. However, if the 3D model of the structure is not included in the data package, then in step 46b the bounding geometry generator 26b of FIG. 1 could generate a real-time bounding geometry or contour of the structure to be imaged and flight plan for the bounding geometry based on a drawing by a user that may be input into the system. The initial flight plan for the bounding geometry could be generated based on a center of the bounding geometry and a radial extension from the center of the bounding geometry, a desired overlap between sequential image captures, an image orientation, a desired image resolution, a ceiling elevation and a floor elevation. The capture area could be identified by any suitable identifier, such as postal address, latitude and longitude coordinates, Global Positioning System (GPS) coordinates, or any other suitable identifier. The initial flight plan could also be generated based on a field of view of a camera attached to the unmanned aircraft, a height of the structure to be captured, and a footprint of the structure to be captured.

In step 50, the system checks for possible collisions between the unmanned aircraft and the obstacles in the capture area by comparing the aerial image data package and the flight plan. If the system determines that there are collisions in step 50, then in step 52, the system modifies the flight plan to avoid the obstacles. Then, in step 54, the system monitors an elevation between the unmanned aircraft and the structure to be imaged. Also, if a negative determination occurs in step 50) no collisions detected, control passes to step 54.

In step 56, the system determines whether there is a change in elevation between the unmanned aircraft and the structure. If the system determines there is not a change in elevation, then in step 58 the system executes the flight plan. Alternatively, if the system determines there is a change in elevation, then in step 60 the system determines whether the unmanned aircraft is equipped with a zoom lens for capturing the high-resolution images of the structure.

If the unmanned aircraft is equipped with a zoom lens, then in step 62 the system adjusts the zoom lens to maintain a desired image resolution based on the change in elevation between the unmanned aircraft and the structure. Then in step 64, the system executes the flight plan. Alternatively, if the unmanned aircraft is not equipped with a zoom lens, then in step 66 the system adjusts a flight plan elevation of the unmanned aircraft to maintain the desired image resolution based on the change in elevation between the unmanned aircraft and the structure. Then in step 68, the system executes the adjusted-elevation flight plan.

It is noted that the system can also automatically generate and execute flight plans for capturing images using a variety of flight paths of various shapes, directions, etc. An example of a flight path in accordance with the present invention is discussed hereinbelow, but it is noted that the system of the present disclosure is not limited to the particular flight paths disclosed herein.

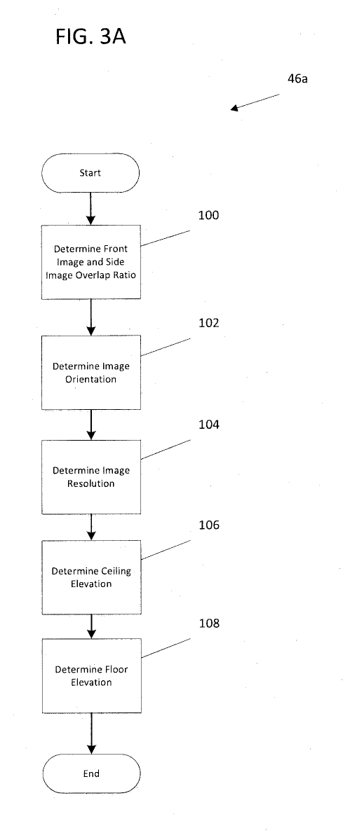

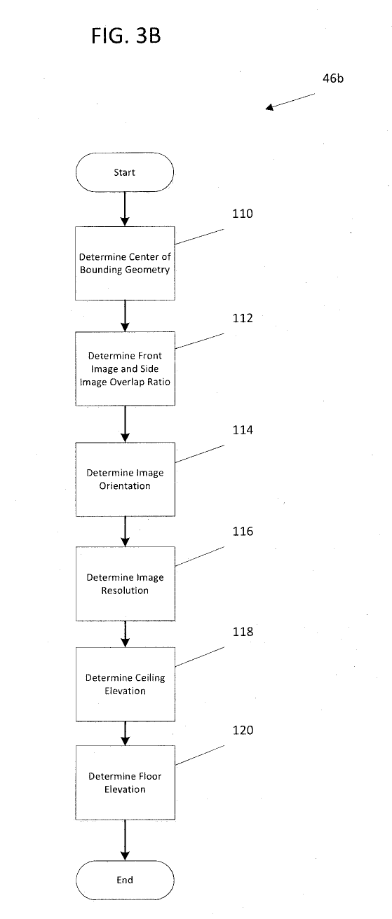

FIG. 3A is a flowchart illustrating, in greater detail, processing steps carried out by the system of the present disclosure in step 46a of FIG. 2. To generate the flight plan for the 3D model, the system calculates the front image and side image overlap ratio in step 100; determines the image orientation in step 102; determines the image resolution in step 104; calculates the ceiling elevation in step 106; and then calculates the floor elevation in step 108. The received 3D model of the structure to be imaged may have each surface specified as a polygon. For example, the surfaces may include but are not limited to a roof face, a wall surface, a sky light, a chimney, etc. Accordingly, the system generates a flight plan for each surface based on the aforementioned inputs and chains the individual flight plans together to complete a high-resolution scan of the structure.

FIG. 3B is a flowchart illustrating, in greater detail, processing steps carried out by the system of the present disclosure in step 46b of FIG. 2. To generate the flight plan for the bounding geometry, the system determines the center of the bounding geometry and radial extensions from the center of the bounding geometry in step 110; calculates the front image and side image overlap ratio in step 112; determines the image orientation in step 114; determines the image resolution in step 116; calculates the ceiling elevation in step 118; and then calculates the floor elevation in step 120.

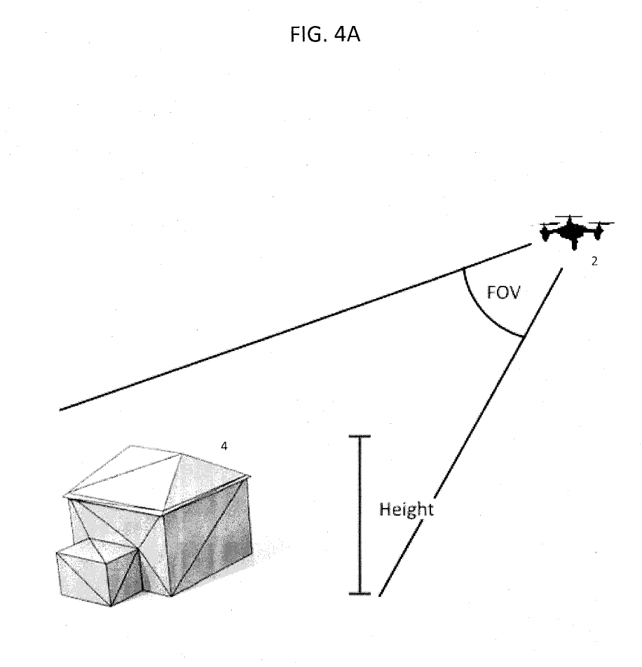

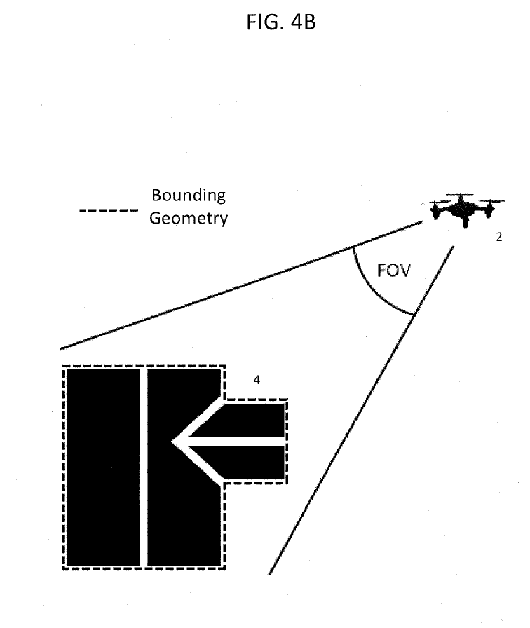

FIGS. 4A-4B are images illustrating the processing steps of FIGS. 3A-3B carried out by the system of the present disclosure. As shown in FIG. 4A, the system generates the flight plan for the 3D model of the structure. Alternatively and as shown in FIG. 4B, the system generates the flight plan for the bounding geometry of the structure.

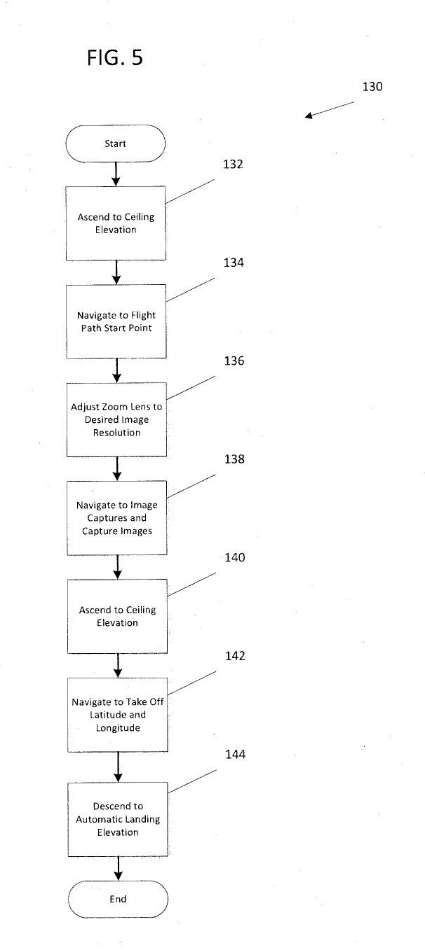

FIG. 5 is a flow chart illustrating processing steps carried out by the flight plan navigation module 28 of the system for generating a flight plan for the unmanned aircraft 2 equipped with a zoom lens. Between take off and landing of the unmanned aircraft 2, there could be seven components of a flight plan including, but not limited to: ascending to a ceiling elevation in step 132; navigating to a flight path start point in step 134; adjusting the zoom lens to a desired image resolution in step 136; navigating to and capturing images in step 138; ascending to the ceiling elevation in step 140; navigating to the take off latitude and longitude in step 142; and descending to an automatic landing elevation in step 144. As noted above, the system of the present disclosure is not limited to the particular flight paths disclosed and discussed herein, which are illustrative in nature. Indeed, the system could plan and automatically execute flight paths of other configurations, shapes, paths, etc. For example, the system could automatically plan and execute flight paths that are arcuate in shape (e.g., orthodromic arcs) or have other geometries (e.g., radial paths, straight flight paths, etc.).

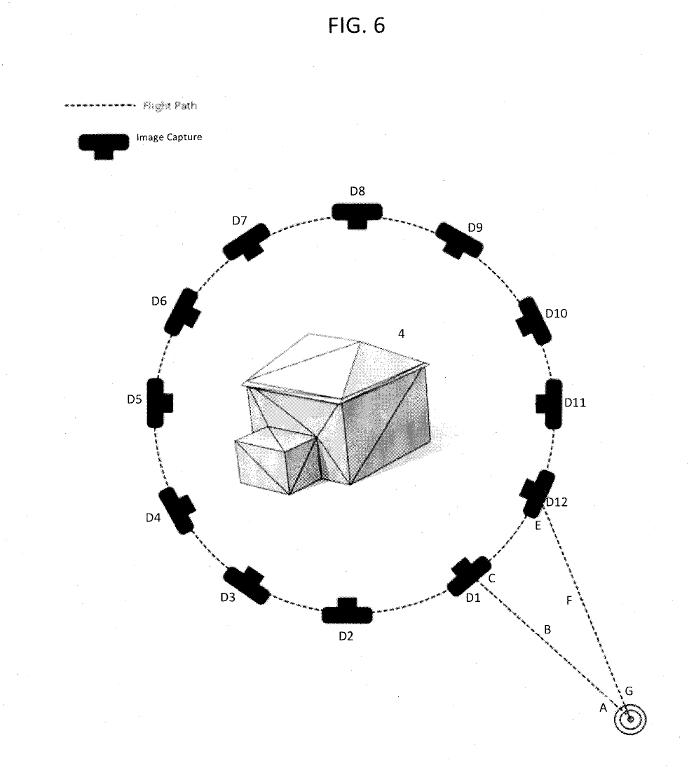

FIG. 6 is a diagram illustrating, as carried out by the processing steps of FIG. 5, generation of a flight plan and a flight path of the unmanned aircraft 2 equipped with a zoom lens. As shown in FIG. 6, the unmanned aircraft 2 ascends to a ceiling elevation at point A before navigating to the flight path start point during point B. Subsequently, the unmanned aircraft 2 adjusts the zoom lens to a desired image resolution at point C before navigating to and capturing views D1-12 in a counter clockwise fashion. Then the unmanned aircraft 2 ascends to the ceiling elevation at point E before navigating to the take off latitude and longitude during point F. At point G, the unmanned aircraft 2 descends from the ceiling elevation to an elevation of five meters before automatically landing.

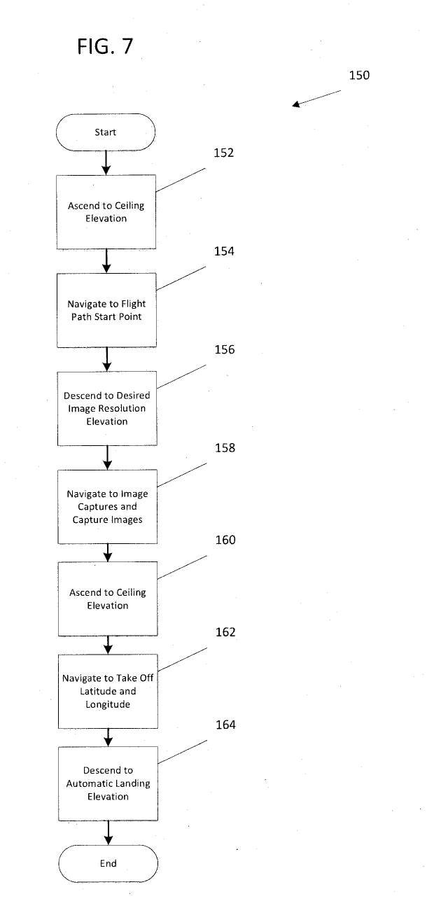

FIG. 7 is a flow chart illustrating processing steps carried out by the flight plan navigation module 28 of the system for generating a flight plan for the unmanned aircraft 2 when the unmanned aircraft is not equipped with a zoom lens. Between take off and landing of the unmanned aircraft 2, there could be seven components of a flight plan including, but not limited to: ascending to a ceiling elevation in step 152; navigating to a flight path start point in step 154; descending to a desired image resolution in step 156; navigating to and capturing images in step 158; ascending to the ceiling elevation in step 160; navigating to the take off latitude and longitude in step 162; and descending to an automatic landing elevation in step 164. As noted above, the system of the present disclosure is not limited to the particular flight paths disclosed and discussed herein, which are illustrative in nature. Indeed, the system could plan and automatically execute flight paths of other configurations, shapes, paths, etc. For example, the system could automatically plan and execute flight paths that are arcuate in shape (e.g., orthodromic arcs) or have other geometries (e.g., radial paths, straight flight paths, etc.).

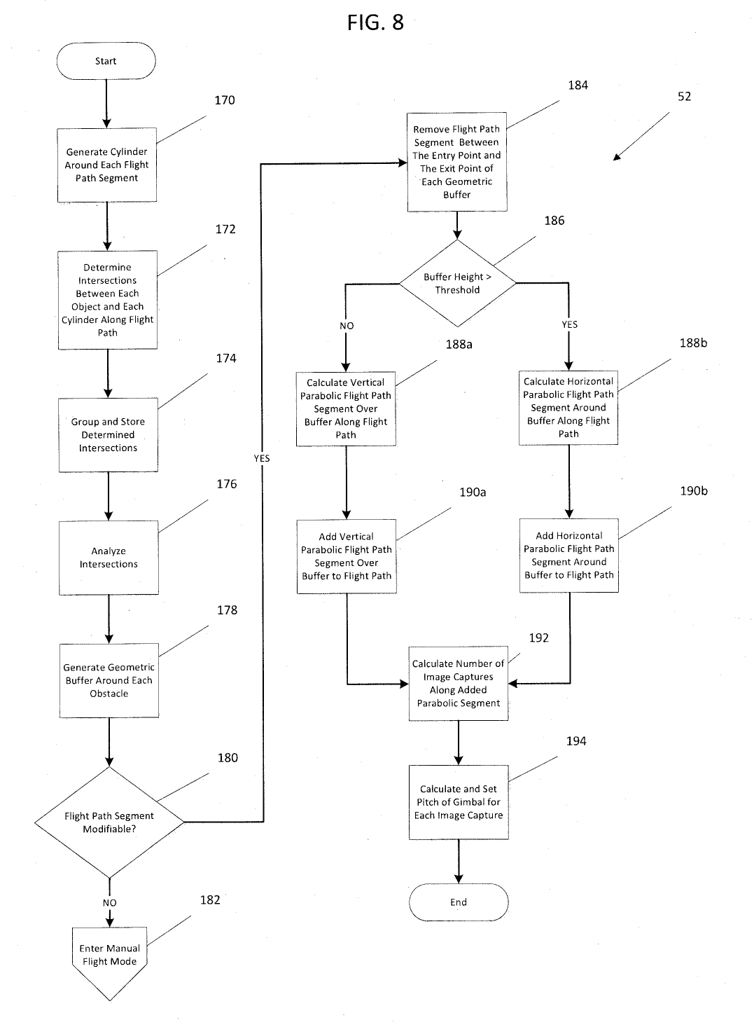

FIG. 8 is a flowchart illustrating step 52 of FIG. 2 in greater detail. Beginning in step 170, the system generates a spatial cylinder around each flight path segment (which is a straight path). Alternatively, the system may generate a spatial torus or section of a torus around each flight path segment (which is a circular path or an arced path, respectively). As noted herein, the flight paths described herein are illustrative in nature and are not limited in scope, and indeed, the system could implement flight paths of various other configurations/shapes/paths without departing from the spirit or scope of the present disclosure. In step 172, the system checks for intersections between each object represented in the downloaded data package and each cylinder, torus, or section of a torus along the flight path. Then in step 174, the system groups and stores the determined intersections first according to the object being intersected and then according to descending order of height (e.g., from highest elevation to lowest elevation). The grouping and storing of the intersections as an ordered collection of intersections allows the system to analyze the intersections together as a block. Therefore, and if necessary, the system can modify the flight path in one pass while considering all intersections, rather than incrementally changing the flight path based on individual intersections. In step 176, each determined intersection is analyzed to determine if it can be handled together in a group with other intersections. Of course, the intersections need not be processed together as a block in order for the system to function.

In step 178, the system generates a geometrically-shaped buffer region (e.g., an ellipsoid, box (parallelepiped), cylinder, or other shape) around each obstacle present in the flight path. The geometric buffer envelopes the entire obstacle with an additional buffer space to ensure the flight path avoids the obstacle. Then and in step 180, the system determines whether the flight path segment affected by the obstacle may be automatically modified by the system. A flight segment may not be automatically modifiable if the obstacle is too tall or large for the unmanned aircraft to effectively avoid. Accordingly, in step 182, the system may enter a manual flight mode such that the flight path will include a manual section of flight directed by the pilot of the unmanned aircraft 2. Alternatively, if the system determines that the flight segment is modifiable, then the system, in step 184, removes all previous flight path segments between an entry point into the geometric buffer region and an exit point out of the buffer region. It is noted that the flight path modification could be executed by the system in real-time, e.g., as the unmanned aircraft 2 is flying, or at any other time (e.g., before the flight path is executed).

In step 186, the system determines whether the height of the geometric buffer exceeds a predefined threshold. The threshold maybe a maximum elevation of the unmanned aircraft, a flight zone elevation restriction, etc. If the system determines that the height of the geometric buffer does not exceed the threshold, then the system in step 188a calculates a vertical parabolic flight path segment over the buffer area in the direction of the original flight path. Accordingly, the system in step 190a then adds the calculated vertical parabolic segment over the geometric buffer to the flight path.

Alternatively, if the system determines the height of the ellipsoid exceeds the predefined threshold, in step 188b the system calculates a horizontal parabolic flight path segment around the geometric buffer in the direction of the original flight path. The horizontal parabolic segment around the geometric buffer is calculated based on the intersection of the plane of the initial flight path and the geometric buffer. Therefore, the horizontal parabolic segment around the geometric buffer should be in the direction toward the structure 4. If the space between the ellipsoid and the structure 4 is insufficient to accommodate the unmanned aircraft 2, an alternate horizontal parabolic segment will be generated which is in the direction away from the structure 4. In either case, the system in step 190b then adds the calculated horizontal parabolic flight path segment around the geometric buffer to the flight path. In step 192, the system calculates a number of image captures along either the vertical parabolic segment over the geometric buffer or the horizontal parabolic segment around the geometric buffer. In step 194, the system calculates and sets a pitch of a gimbal of the unmanned aircraft for each image to capture the entire structure 4 (or, alternatively, for capturing a portion or feature of the structure, target feature, etc.). Additionally, if needed, the system can adjust the zoom setting on the lens of the camera in step 194.

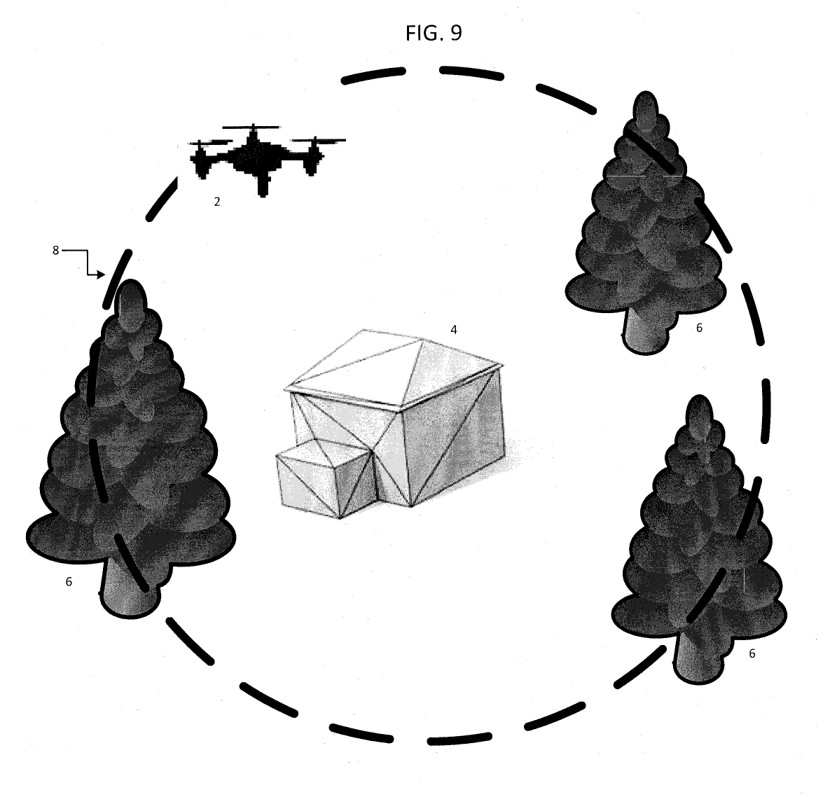

FIG. 9 is a diagram illustrating a flight path of a generated flight plan. The initial flight plan for the 3D model of the structure 4 is generated based on a front image and side image overlap ratio, an image orientation, a desired image resolution, a ceiling elevation and a floor elevation. Alternatively, the initial flight plan for the bounding geometry could be generated based on a center of the bounding geometry and a radial extension from the center of the bounding geometry, a front image and side image overlap ratio, an image orientation, a desired image resolution, a ceiling elevation and a floor elevation. The initial flight plan may also be generated based on a field of view of a camera attached to the unmanned aircraft 2, a height of the structure 4 to be captured and a footprint of the structure 4 to be captured. In addition, the system checks for possible collisions between the unmanned aircraft 2 and obstacles 6 in the capture area by comparing the aerial image data package and the initial flight plan. As shown in FIG. 9, collisions may exist between the unmanned aircraft 2 and obstacles 6 such as trees along flight path segments 8, etc.

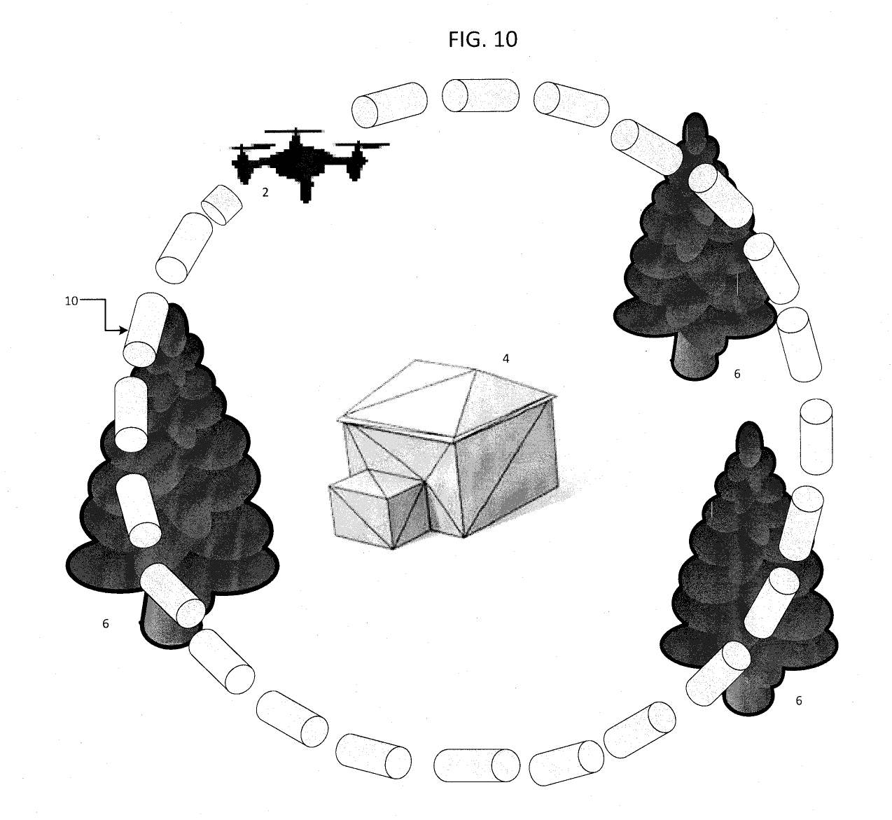

FIG. 10 is a diagram illustrating a flight path of a generated flight plan according to step 170 of FIG. 8. As noted above, in step 170, the system generates a cylinder 10 around each flight path segment 8 of FIG. 9. Alternatively, the system may generate a torus or section of a torus around each flight path segment 8 of FIG. 9. In step 172, the system checks for intersections between each obstacle 6 present in the flight path and each cylinder 10 along the flight path. It is noted that the size of each flight path segment 8 could be pre-defined (e.g., set to a fixed value), specified by a user in advance of (or, during) a flight, and/or dynamically modified as required (e.g., during a flight).

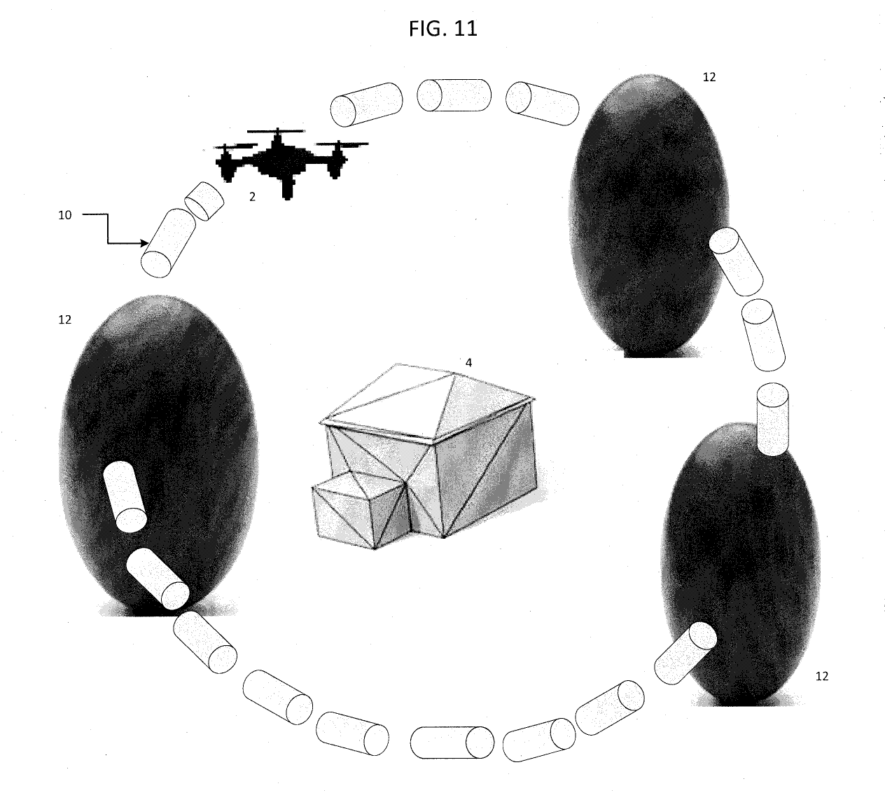

FIG. 11 is a diagram illustrating a flight path of a generated flight plan according to step 178 of FIG. 8. As noted above, in step 178, the system generates a geometric buffer 12 (as shown, an ellipsoid, although other shapes are possible) around each obstacle 6 present in the flight path. The geometric buffer 12 envelopes the entire obstacle 6 with an additional buffer to ensure the flight path avoids the obstacle 6. Then the system determines whether the flight path segment 8 affected by the intersection between the obstacle 6 present in the flight path and the cylinder 10 (or, section of a torus) along the flight path may be modified. If the system determines the flight segment 8 is modifiable, then the system in step 184 removes all flight path segments 8 between an entry point into the geometric buffer 12 and an exit point out of the geometric buffer 12.

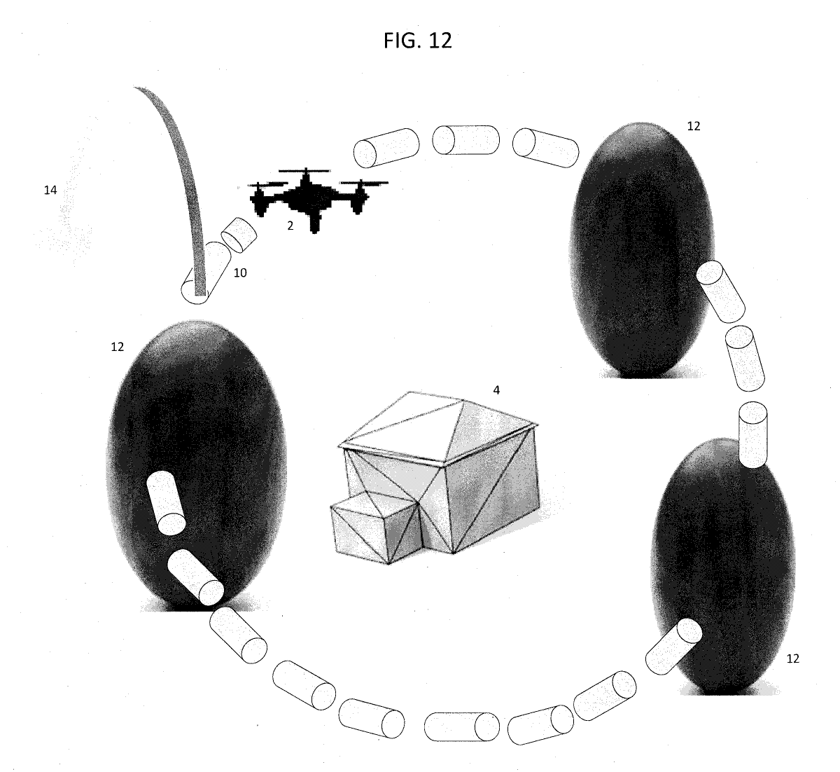

FIG. 12 is a diagram illustrating a flight path of a generated flight plan according to steps 188a and 190a of FIG. 8. If the system determines a height of the geometric buffer 12 does not exceed a predefined threshold, then the system in step 188a calculates a vertical parabolic segment 14 over the geometric buffer 12 along the flight path. Accordingly, the system in step 190a then adds the calculated vertical parabolic segment 14 over the geometric buffer 12 to the flight path.

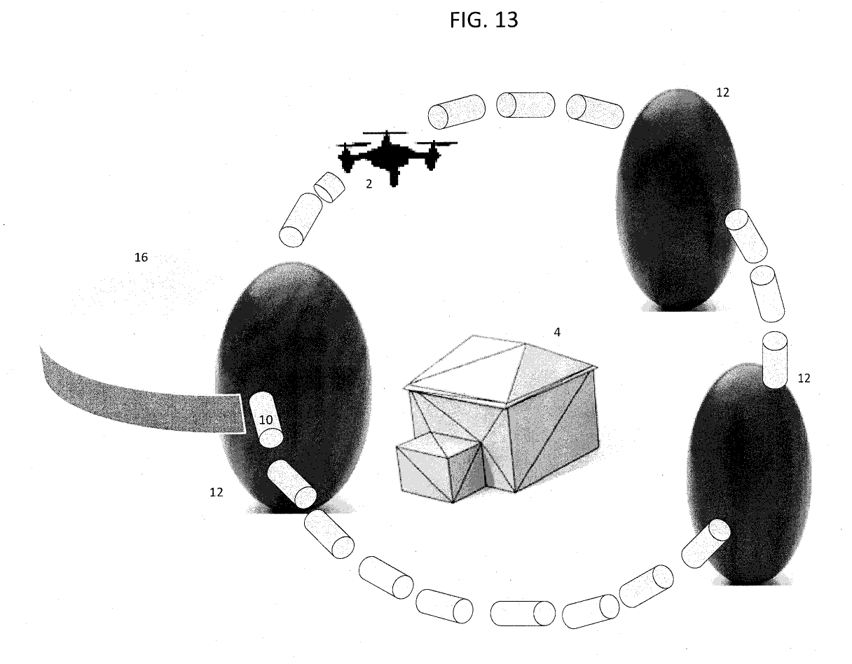

FIG. 13 is a diagram illustrating a flight path of a generated flight plan according to steps 188b and 190b of FIG. 8. Alternatively, if the system determines the height of the geometric buffer 12 exceeds the predefined threshold, in step 188b the system calculates a horizontal parabolic segment 16 around the geometric buffer 12 along the flight path. The horizontal parabolic segment 16 around the geometric buffer 12 is calculated based on the intersection of the plane of the initial flight path and the geometric buffer 12. Therefore, the horizontal parabolic segment 16 around the geometric buffer 12 should go around the geometric buffer 12. Accordingly, the system in step 190b then adds the calculated horizontal parabolic segment 16 around the geometric buffer 12 to the flight path.

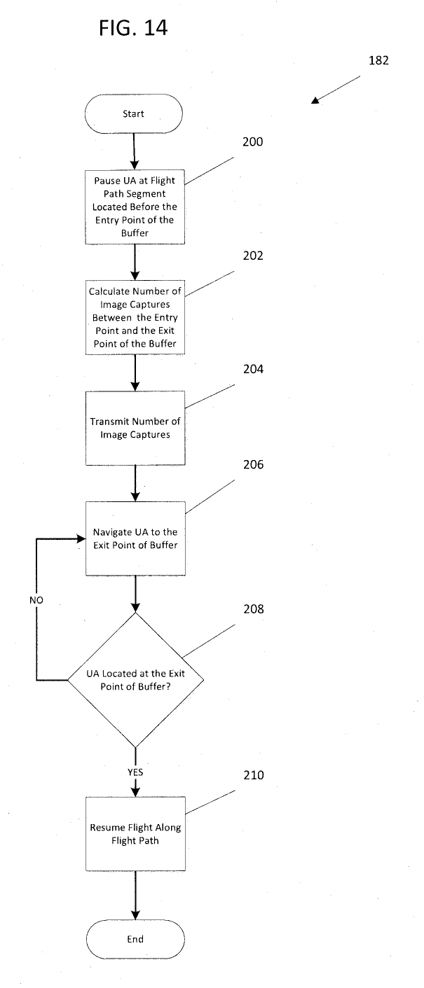

FIG. 14 is a flowchart illustrating step 182 of FIG. 8 in greater detail. A flight segment may not be automatically modifiable if the obstacle is too tall or large for the unmanned aircraft 2 to effectively avoid. Accordingly, in step 182 the system may enter a manual flight mode such that the flight path will include a manual section of flight directed by a user of the system (e.g. a pilot). In step 200, the unmanned aircraft 2 will pause at a flight path segment located before an entry point of the geometric buffer 12. In step 202, the system calculates a number of images to be captured between the flight path segment located before the entry point of the geometric buffer 12 and an exit point of the geometric buffer 12 (i.e., a resumption point). Therefore, the system calculates a number of images that should be captured between the pause point of unmanned aircraft 2 and a point at which the system will resume control of the unmanned aircraft 2. The system, in step 204, transmits the number of images to be captured to the user of the system.

In step 206, the user navigates the unmanned aircraft 2 to the resumption point. While navigating the unmanned aircraft 2, the system may assist the user by providing updates relating to absolute, horizontal and vertical distance. In such circumstances, the user can add images to replace those that may have been removed from the flight plan because of an obstacle. Such images can be captured as the user navigates the unmanned aircraft 2 to the resumption point, if desired. Additionally, the system may provide an update regarding an orientation of the resumption point relative to the position of the unmanned aircraft 2. In step 208, the system determines whether the unmanned aircraft 2 has arrived at the resumption point. If the system determines the unmanned aircraft 2 has not arrived at the resumption point, the user maintains control of the unmanned aircraft 2 and continues to navigate the unmanned aircraft 2 until arriving at the resumption point. In step 210, if the unmanned aircraft 2 arrives at the resumption point, the system resumes control of the unmanned aircraft 2 and resumes flight along the flight path of the flight plan. For example, the system may notify the user that the system is ready to resume control of the unmanned aircraft 2 and in response the unmanned aircraft 2 may hover in place until the user commands the system to resume the flight plan.

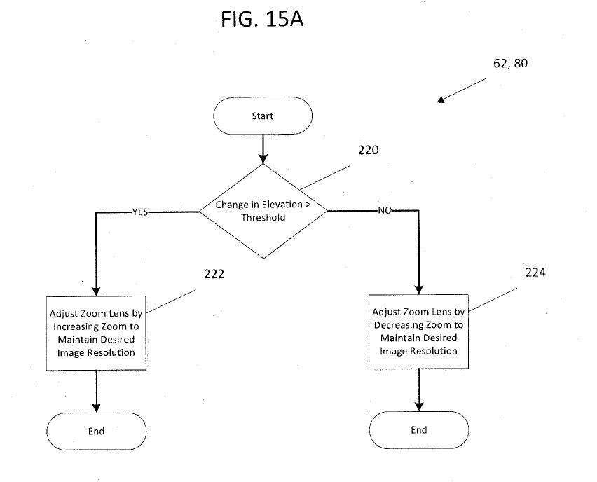

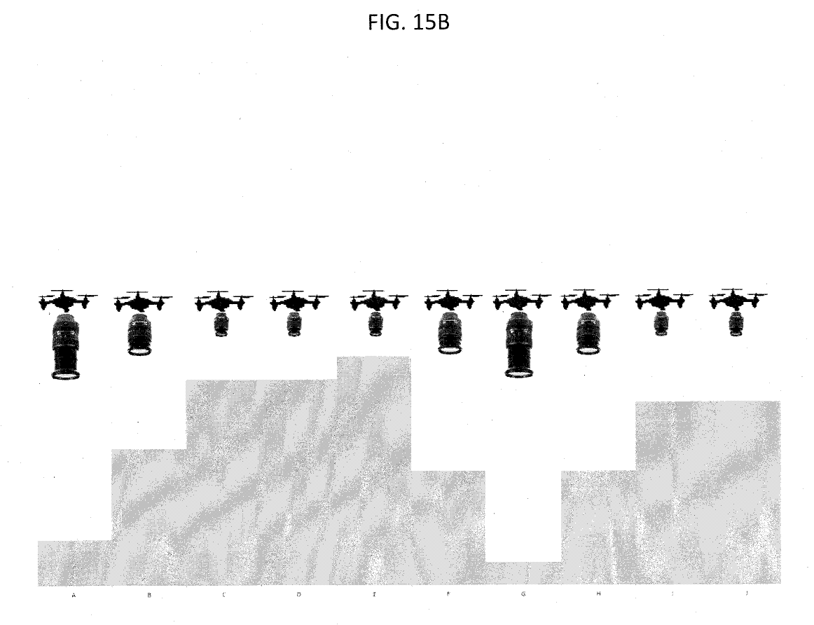

FIG. 15A is a flowchart illustrating steps 62 and 80 of FIG. 2 in greater detail. As discussed above, if the system determines that there is a change in elevation between the unmanned aircraft 2 and the structure 4, then the system determines whether the unmanned aircraft 2 is equipped with a zoom lens for capturing the high-resolution images of the structure 4. Changes in elevation between the unmanned aircraft and the structure, and/or the direct (linear) distance between the aircraft and the structure, can be determined using any suitable sensor on-board the unmanned aicraft, such as sonar, radar, LIDAR, etc., or by computing the elevation and/or distance using the present position and elevation of the aircraft (as determined by global positioning system (GPS) data, for example) and pre-defined structure elevation information stored in digital elevation model (DEM), digital surface model (DSM), digital terrain model (DTM), property database, or from any other source of information. If the unmanned aircraft 2 is equipped with a zoom lens, then in step 220 the system determines whether the change in elevation between the unmanned aircraft 2 and the structure 4 exceeds a predetermined threshold. Based on the determination, the system adjusts the zoom lens to maintain the desired image resolution. For example, if the change in elevation exceeds the predetermined threshold, then in step 222 the system adjusts the zoom lens by increasing the level of zoom to maintain the desired image resolution for capturing the high-resolution images of the structure 4. Alternatively, if the change in elevation does not exceed the predetermined resolution, then in step 224 the system adjusts the zoom lens by decreasing the level of zoom to maintain the desired image resolution for capturing the high-resolution images of the structure 4.

FIG. 15B is a diagram illustrating a flight path of a flight plan of the unmanned aircraft 2 equipped with a zoom lens. For example, points A-J may represent respective surfaces of the structure 4 along the flight path and the corresponding level of zoom (e.g., high, medium or low) required per point to capture the high-resolution images of the structure 4. As discussed above, the level of zoom is based on the change in elevation between the unmanned aircraft 2 and the structure 4. For example, as the unmanned aircraft 2 progresses along the flight path, the level of zoom changes from one point to the next point.

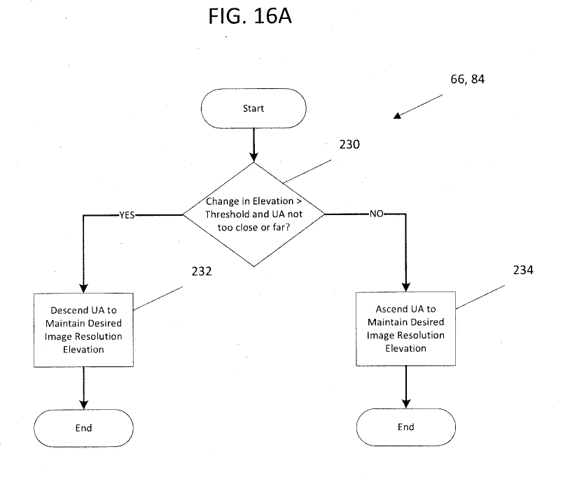

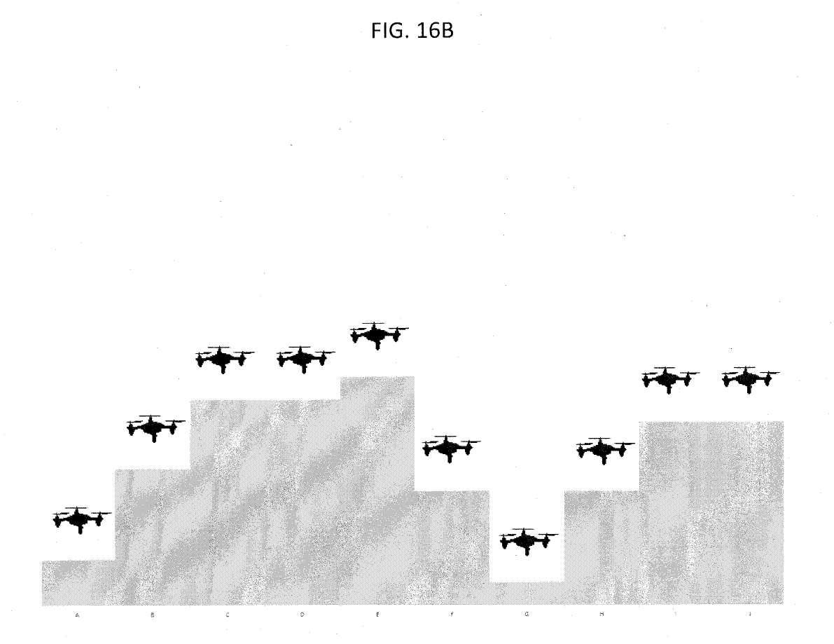

FIG. 16A is a flowchart illustrating steps 66 and 84 of FIG. 2 in greater detail. As discussed above, if the system determines that there is a change in elevation between the unmanned aircraft 2 and the structure 4, then the system determines whether the unmanned aircraft 2 is equipped with a zoom lens for capturing the high-resolution images of the structure 4. If the unmanned aircraft 2 is not equipped with a zoom lens, then in step 230 the system determines: (1) whether the change in elevation between the unmanned aircraft 2 and the structure 4 exceeds a predetermined threshold; and (2) if the aircraft is too close or too far from the structure. Based on the determination, the system adjusts the elevation of the unmanned aircraft 2 to maintain a desired image resolution. For example, if the change in elevation exceeds the predetermined threshold, then in step 232 the system adjusts the elevation of the unmanned aircraft 2 by descending the unmanned aircraft 2 to maintain the desired image resolution for capturing the high-resolution images of the structure 4. Alternatively, if the change in elevation does not exceed the predetermined resolution, then in step 224 the system adjusts the elevation of the unmanned aircraft 2 by ascending the unmanned aircraft 2 to maintain the desired image resolution for capturing the high-resolution images of the structure 4.

FIG. 16B is a diagram illustrating a flight path of a flight plan of the unmanned aircraft 2 when the unmanned aircraft is not equipped with a zoom lens. For example, points A-J may represent respective surfaces of the structure 4 along the flight path and the corresponding elevation level of the unmanned aircraft 2 required per point to capture the high-resolution images of the structure 4. As discussed above, the change in elevation of the unmanned aircraft 2 is based on the change in elevation between the unmanned aircraft 2 and the structure 4 from one point to the next point.

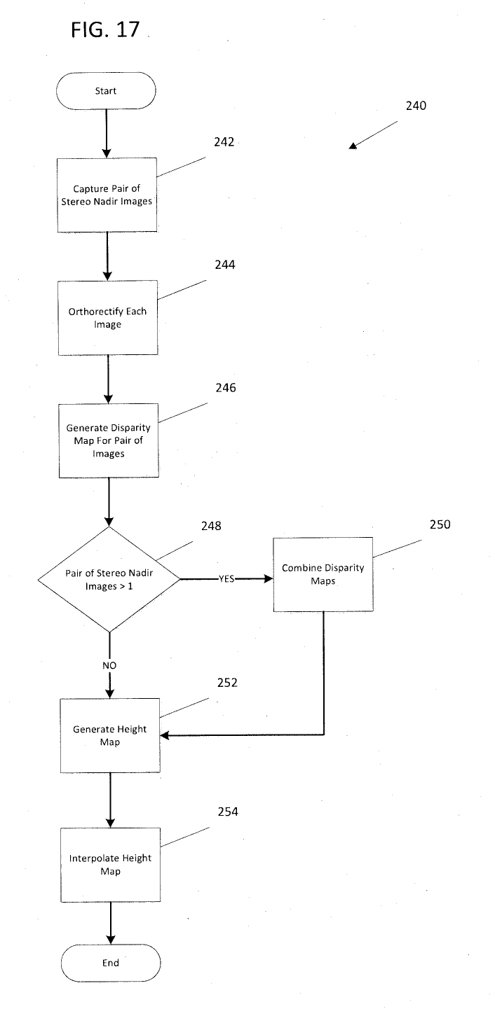

FIG. 17 is a flowchart illustrating the processing steps carried out by the real-time aerial map generator 26a of FIG. 1. As discussed above, the system may download an aerial image data package of the area to be captured. The data package could be a pre-existing digital terrain model (DTM) including, but not limited to, flight path obstacles such as residential and commercial buildings, flagpoles, water towers, windmills, street lamps, trees, power lines, etc.

Alternatively, the real-time aerial map generator 26a could generate a real-time DTM. The real-time generation of a DTM is advantageous because pre-existing DTMs may be outdated which may lead to inefficiencies when generating a flight plan and comparing the flight plan against the DTM. For example, natural disasters such as floods, fires, earthquakes, tornadoes, hurricanes and the like may change the natural topography of the capture area and/or destroy the flight path obstacles located within the capture area. In another example, rapid development of a capture area due to gentrification or the discovery of natural resources could result in the sudden existence or construction of flight path obstacles such as cranes, skyscrapers, oil rigs, etc.

Beginning in step 242, the system captures at least one pair of stereo nadir images. The number of stereo pairs required may depend on a size of the capture area and a height at which the stereo nadir images are captured. It may be advantageous to capture at least one pair of stereo nadir images at a lower elevation to ensure a higher resolution of the images captured and as such that obstacles are accurately detected and dimensioned. Additionally, stereo nadir image pairs may be chained together such that a single image may be used in several stereo pairs. In step 244, the system orthorectifies each image, based on the field of view of a camera attached to the unmanned aircraft 2 and distortion parameters of the camera, to correct each image due to lens distortion. Then in step, 246 the system will generate a disparity map for each pair of stereo nadir images.

In step 248, the system determines whether the number of pairs of stereo nadir images is greater than one. If the system determines the number of pairs of stereo nadir images is greater than one, then the system in step 250 combines the disparity maps of each stereo pair into a single disparity map. Subsequently, the system generates a height map in step 252, based on the single disparity map, by triangulating each point in the disparity map using a location of the unmanned aircraft 2 and at least one view vector of the unmanned aircraft 2. The system or an external server may generate the height map based on available processing speed.

Alternatively, if the system determines the number of pairs of stereo is not greater than one, then the system proceeds to step 252 and generates a height map as discussed above. The generated height map in step 252 may be used as a DSM. However and as shown in FIG. 17, the system may interpolate the height map in step 254 into other formats for expedited processing. For example, the system could process intersections of an exemplary flight path with a mesh or collection of geometries more quickly than with the height map or point cloud.

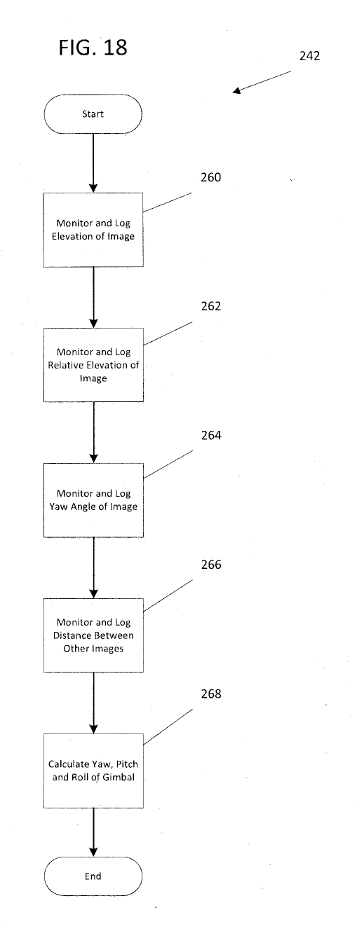

FIG. 18 is a flowchart illustrating step 242 of FIG. 17 in greater detail. The system captures at least one pair of stereo nadir images and monitors and logs parameters of each image while capturing at least one pair of stereo nadir images. Beginning in step 260, the system monitors and logs an elevation of an image. In step 262, the system monitors and logs a relative elevation of the image in comparison to other images. Then, in step 264, a yaw angle of the image is monitored and logged before a distance between the image and other images is monitored and logged in step 266. Lastly, in step 268, the system calculates a yaw angle, pitch and roll of the gimbal.

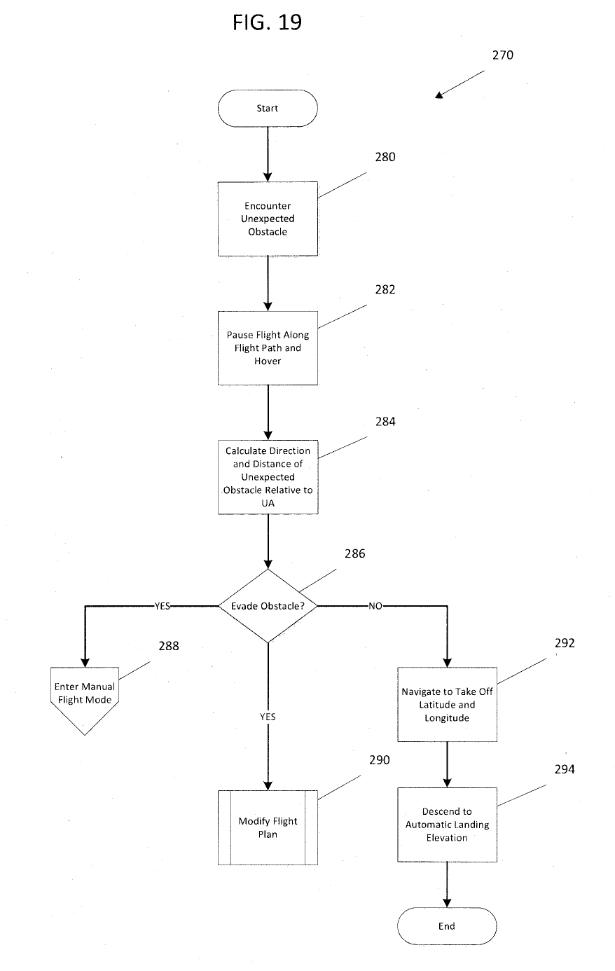

FIG. 19 is a flowchart illustrating steps 70 and 92 of FIG. 2 in greater detail and as carried out by the dynamic flight plan modification module 32c of FIG. 1. Despite efforts to provide the system with an accurate DTM of the capture area, the unmanned aircraft 2 may encounter unexpected obstacles. Alternatively, a DTM of the capture area may not be available or one may not have the resources to generate a real-time DTM. In the above cases, the system may provide for the unmanned aircraft 2 to dynamically evade obstacles present in a flight path by monitoring at least one sensor of the unmanned aircraft 2 along a flight path of a flight plan.

Beginning in step 280, the unmanned aircraft 2 encounters an unexpected obstacle. Accordingly, in step 282 the unmanned aircraft 2 will pause flight along the flight path and hover. Additionally, the system may notify a user of the system of the unexpected obstacle. Subsequently, the system in step 284 will query the at least one sensor of the unmanned aircraft 2 to calculate a direction and distance of the unexpected obstacle relative to the unmanned aircraft 2. Based on the calculation, the system will provide the user with options for evading the unexpected obstacle or an option to abort the flight plan.

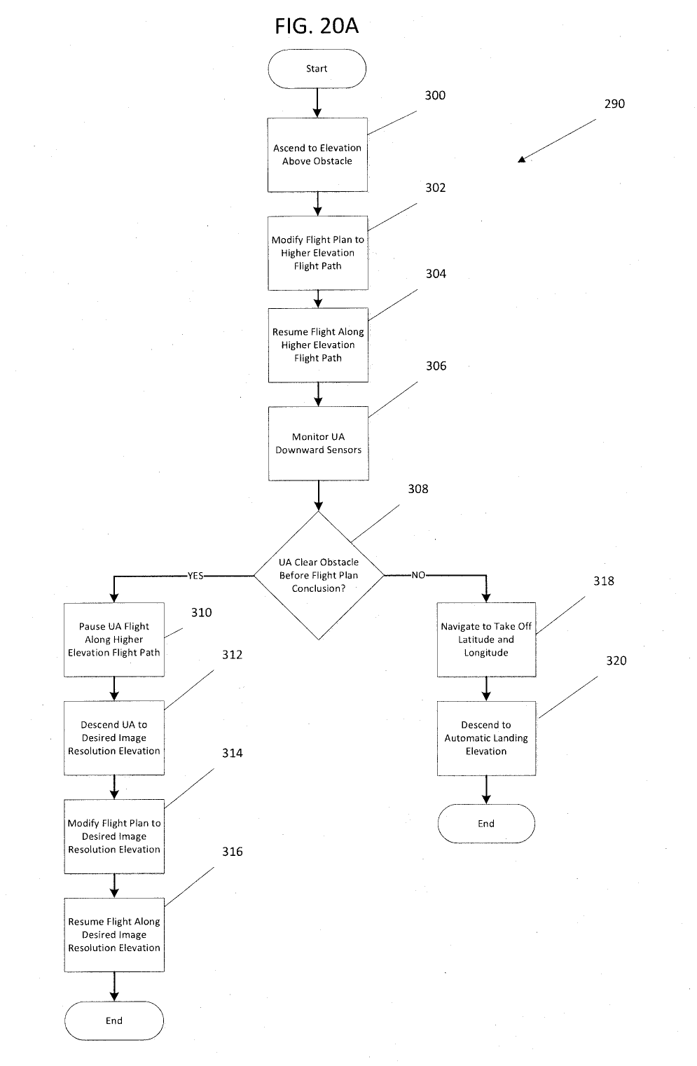

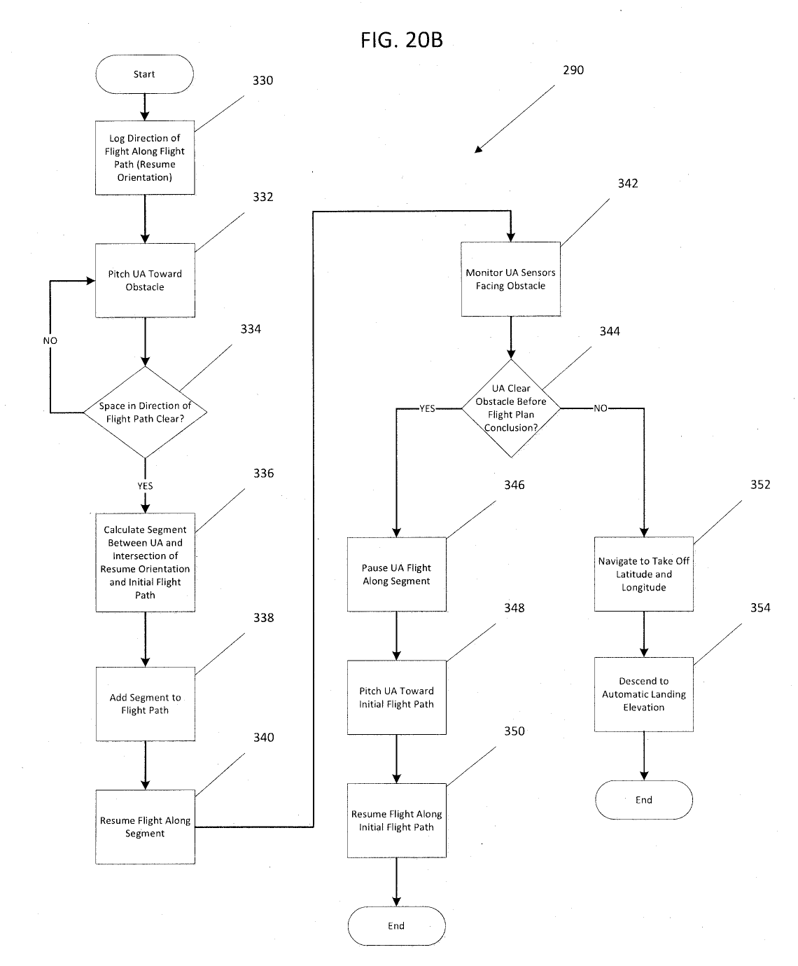

For example, in step 288 the user may elect to evade the obstacle by assuming manual flight control of the unmanned aircraft 2 as discussed above in reference to FIG. 14. In step 290 the user may also elect to evade the obstacle by modifying the flight plan as discussed below in reference to FIGS. 20A-20B. Alternatively, the user may elect to abort the flight plan by navigating to the take off latitude and longitude in step 292 and descending to an automatic landing elevation in step 294.

FIG. 20A is a flowchart illustrating step 290 of FIG. 19 in greater detail. The user may elect to evade the unexpected obstacle by navigating over the obstacle. Accordingly, in step 300 the system may slowly ascend the unmanned aircraft 2 to an elevation above the obstacle. Upon arriving at the higher elevation, the system in step 302 modifies the flight to plan to correspond to the higher elevation flight path. In step 304, the system resumes flight along the higher elevation flight path.

As shown in step 306, while resuming flight the system monitors at least one downward sensor of the unmanned aircraft 2 to detect when the unmanned aircraft 2 may return to an initial flight path elevation for the desired image resolution. If the system determines in step 308 that the unmanned aircraft 2 has not cleared the obstacle before a conclusion of the flight plan, the system will navigate the unmanned aircraft 2 to the take off latitude and longitude in step 318 and descend the unmanned aircraft 2 to an automatic landing elevation in step 320. Alternatively, if the system determines the unmanned aircraft 2 has cleared the obstacle before the conclusion of the flight plan, the system will execute a procedure to return the unmanned aircraft 2 to the initial flight path elevation for the desired image resolution. In step 310, the system will pause the flight of the unmanned aircraft 2 along the higher elevation flight path before descending the unmanned aircraft 2 to the initial flight path elevation for the desired image resolution in step 312. Subsequently, in step 314 the system will modify the flight plan to correspond to the initial elevation flight path for the desired image resolution and will resume flight of the unmanned aircraft 2 along the initial elevation flight path for the desired image resolution in step 316.

FIG. 20B is a flowchart illustrating step 290 of FIG. 19 in greater detail. The user may elect to evade the unexpected obstacle by navigating around the obstacle. Beginning in step 330, the system logs a direction of flight of the unmanned aircraft 2 along the flight path (i.e., the resume orientation). Then, the system, in step 332, pitches the unmanned aircraft 2 toward the obstacle until the space in the direction of the flight path is clear. If the space in the direction of the flight path is not clear in step 334, the system continues to pitch the unmanned aircraft 2 toward the obstacle. Otherwise, the system proceeds to step 336 and calculates a segment between the unmanned aircraft 2 and an intersection of the resume orientation and the initial flight path. In step 338, the system adds the calculated segment to the flight path and in step 340 the unmanned aircraft 2 resumes flight along the added segment.

As shown in step 342, while resuming flight the system monitors at least one sensor of the unmanned aircraft 2 facing the obstacle to detect when the unmanned aircraft 2 may return to the initial flight path. If the system determines the unmanned aircraft 2 has not cleared the obstacle before a conclusion of the flight plan, the system will navigate the unmanned aircraft 2 to the take off latitude and longitude in step 352 and descend the unmanned aircraft 2 to an automatic landing elevation in step 354. Alternatively, if the system determines the unmanned aircraft 2 has cleared the obstacle before the conclusion of the flight plan, the system will execute a procedure to return the unmanned aircraft 2 to the initial flight path. In step 346, the system will pause the flight of the unmanned aircraft 2 along the added segment before pitching the unmanned aircraft 2 toward the initial flight path in step 348. Subsequently, in step 350 the system will resume flight of the unmanned aircraft 2 along the initial flight path.

The system of the present disclosure could also include functionality for dynamically navigating around objects based on a classification system, in real-time as the unmanned aircraft 2 is in flight. For example, the system could classify a nearby object (such as a tree, power line, etc.), and based on the classification, the system could navigate the unmanned aircraft 2 a predefined distance away from the object. Indeed, for example, the system could navigate the unmanned aircraft 2 a pre-defined distance of 20 feet away from an object if the object is classified as a power line, and another distance (e.g., 10 feet) away from an object if the object is classified as a tree. Such a system could implement machine learning techniques, such that the system learns how to classify objects over time and as a result, automatically determines what distances should be utilized based on classifications of objects. Still further, the system could detect unexpected objects (such as birds, other aircraft, etc.) and could navigate the unmanned aircraft away from such objects in real-time.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. A method for generating a flight plan for an unmanned vehicle and controlling the unmanned vehicle using the flight plan to capture high-resolution images of a structure, comprising the steps of:
processing aerial imagery data to generate a flight plan for the unmanned vehicle;
determining whether a change in elevation exists between the unmanned vehicle and the structure;
if the change in elevation does not exist, executing the flight plan to capture at least one high-resolution image of the structure; and
if the change in elevation does exist, adjusting an elevation of the flight plan to create an adjusted flight plan and executing the adjusted flight plan to capture at least one high-resolution image of the structure.

2. The method of claim 1, further comprising comparing the aerial image data to the flight plan to determine whether a possible collision exists along a flight path of the flight plan.

3. The method of claim 2, further comprising modifying the flight plan to avoid the possible collision.

4. The method of claim 2, wherein the step of determining whether a possible collision exists along the flight path comprises generating a geometric buffer around each obstacle in the flight path and adding a flight path segment to the flight path around each obstacle.

5. The method of claim 4, wherein the step of adding the flight path segment comprises adding a vertical parabolic flight path around each obstacle.

6. The method of claim 4, wherein the step of adding the flight path segment comprises adding a horizontal parabolic flight path around each obstacle.

7. The method of claim 1, wherein the step of processing the aerial imagery data to generate the flight plan comprises processing a three-dimensional model of the structure to generate the flight plan.

8. The method of claim 1, wherein the step of processing the aerial imagery data to generate the flight plan comprises processing a contour of the structure to generate the flight plan.

9. The method of claim 1, further comprising adjusting an elevation of the unmanned vehicle to maintain a desired image resolution.

10. The method of claim 1, further comprising determining whether an obstacle exists in a path of the flight plan and, in response to the obstacle, performing one or more of: entering a manual flight control mode, modifying the flight plan, or descending the unmanned vehicle to an automatic landing elevation.

11. A method for generating a flight plan for an unmanned vehicle and controlling the unmanned vehicle using the flight plan to capture high-resolution images of a structure, comprising the steps of:
processing aerial imagery data to generate a flight plan for the unmanned vehicle;
determining whether a change in elevation exists between the unmanned vehicle and the structure;
if the change in elevation does not exist, executing the flight plan to capture at least one high-resolution image of the structure; and
if the change in elevation does exist, adjusting a lens of the unmanned aerial vehicle and executing the flight plan to capture at least one high-resolution image of the structure.

12. The method of claim 11, further comprising comparing the aerial image data to the flight plan to determine whether a possible collision exists along a flight path of the flight plan.

13. The method of claim 12, further comprising modifying the flight plan to avoid the possible collision.

14. The method of claim 12, wherein the step of determining whether a possible collision exists along the flight path comprises generating a geometric buffer around each obstacle in the flight path and adding a flight path segment to the flight path around each obstacle.

15. The method of claim 14, wherein the step of adding the flight path segment comprises adding a vertical parabolic flight path around each obstacle.

16. The method of claim 14, wherein the step of adding the flight path segment comprises adding a horizontal parabolic flight path around each obstacle.

17. The method of claim 11, wherein the step of processing the aerial imagery data to generate the flight plan comprises processing a three-dimensional model of the structure to generate the flight plan.

18. The method of claim 11, wherein the step of processing the aerial imagery data to generate the flight plan comprises processing a contour of the structure to generate the flight plan.

19. The method of claim 11, further comprising adjusting an elevation of the unmanned vehicle to maintain a desired image resolution.

20. The method of claim 11, further comprising determining whether an obstacle exists in a path of the flight plan and, in response to the obstacle, performing one or more of: entering a manual flight control mode, modifying the flight plan, or descending the unmanned vehicle to an automatic landing elevation.

21. A system for generating a flight plan for an unmanned vehicle and controlling the unmanned vehicle using the flight plan to capture high-resolution images of a structure, comprising:
an aerial imagery database including aerial imagery data; and
a controller in communication with the aerial imagery database and controlling operation of the unmanned vehicle, the controller:
processing aerial imagery data to generate a flight plan for the unmanned vehicle;
determining whether a change in elevation exists between the unmanned vehicle and the structure;
if the change in elevation does not exist, executing the flight plan to capture at least one high-resolution image of the structure; and
if the change in elevation does exist, adjusting an elevation of the flight plan to create an adjusted flight plan and executing the adjusted flight plan to capture at least one high-resolution image of the structure.

22. The system of claim 21, wherein the controller compares the aerial image data to the flight plan to determine whether a possible collision exists along a flight path of the flight plan.

23. The system of claim 22, wherein the controller modifies the flight plan to avoid the possible collision.

24. The system of claim 22, wherein the controller generates a geometric buffer around each obstacle in the flight path and adds a flight path segment to the flight path around each obstacle.

25. The system of claim 24, wherein the controller adds a vertical parabolic flight path around each obstacle.

26. The system of claim 24, wherein the controller adds a horizontal parabolic flight path around each obstacle.

27. The system of claim 21, wherein the controller processes a three-dimensional model of the structure to generate the flight plan.

28. The system of claim 21, wherein the controller processes a contour of the structure to generate the flight plan.

29. The system of claim 21, wherein the controller adjusts an elevation of the unmanned vehicle to maintain a desired image resolution.

30. The system of claim 21, wherein the controller determines whether an obstacle exists in a path of the flight plan and, in response to the obstacle, performs one or more of: entering a manual flight control mode, modifying the flight plan, or descending the unmanned vehicle to an automatic landing elevation.

31. A system for generating a flight plan for an unmanned vehicle and controlling the unmanned vehicle using the flight plan to capture high-resolution images of a structure, comprising:
an aerial imagery database including aerial imagery data; and
a controller in communication with the aerial imagery database and controlling operation of the unmanned vehicle, the controller:
processing aerial imagery data to generate a flight plan for the unmanned vehicle;
determining whether a change in elevation exists between the unmanned vehicle and the structure;
if the change in elevation does not exist, executing the flight plan to capture at least one high-resolution image of the structure; and
if the change in elevation does exist, adjusting a lens of the unmanned aerial vehicle and executing the flight plan to capture at least one high-resolution image of the structure.

32. The system of claim 31, wherein the controller compares the aerial image data to the flight plan to determine whether a possible collision exists along a flight path of the flight plan.

33. The system of claim 32, wherein the controller modifies the flight plan to avoid the possible collision.

34. The system of claim 32, wherein the controller generates a geometric buffer around each obstacle in the flight path and adds a flight path segment to the flight path around each obstacle.

35. The system of claim 34, wherein the controller adds a vertical parabolic flight path around each obstacle.

36. The system of claim 34, wherein the system adds a horizontal parabolic flight path around each obstacle.

37. The system of claim 31, wherein the system processes a three-dimensional model of the structure to generate the flight plan.

38. The system of claim 31, wherein the system processes a contour of the structure to generate the flight plan.

39. The system of claim 31, wherein the system adjusts an elevation of the unmanned vehicle to maintain a desired image resolution.

40. The system of claim 31, wherein the system determines whether an obstacle exists in a path of the flight plan and, in response to the obstacle, performs one or more of: entering a manual flight control mode, modifying the flight plan, or descending the unmanned vehicle to an automatic landing elevation.
